(19) United States
(12) Patent Application Publication
(10) Pub. No.: US 2017/0102027 A1
(43) Pub. Date: Apr. 13, 2017

(54) BALL JOINT HOUSING

(71) Applicant: PRIMAX CORPORATION, Wonju-si (KR)

(72) Inventors: Hyeonju WON, Wonju-si (KR); Seungbin PARK, Wonju-si (KR)

(73) Assignee: PRIMAX CORPORATION, Wonju-si (KR)

(21) Appl. No.: 15/291,047

(22) Filed: Oct. 11, 2016

(30) Foreign Application Priority Data
Oct. 12, 2015 (KR) 10-2015-0141963

(51) Int. Cl. F16C 11/06

(52) U.S. Cl. CPC F16C 11/0619; F16C 11/0671

(57) ABSTRACT

The present invention relates to a ball joint housing which pivotably supports a ball head of a ball stud received in an inner space thereof and in which a dust cover is installed to prevent foreign substances from entering into the inner space, includes: a receiving limit providing portion for providing a limit in receiving the ball head in the inner space; a contact portion integrally formed with the receiving limit providing portion, wherein the dust cover is brought into contact with the contact portion; and a deformation portion integrally formed with the contact portion; wherein a process in which the deformation portion is deformed inwardly proceeds when the ball head is received in the inner space, wherein the ball head received in the inner space is prevented from being separated by the process.

CROSS-REFERENCE TO RELATED PATENT APPLICATION

This application claims the benefit of Korean Patent Application No. 10-2015-0141963, filed on Oct. 12, 2015, in the Korean Intellectual Property Office, the disclosure of which is incorporated herein in its entirety by reference.

### BACKGROUND OF THE INVENTION

1. Field of the Invention

The present invention relates to a ball joint housing, and more particularly, to a ball joint housing having maximized durability by improving pull-out load of a ball stud.

2. Description of the Related Art

In general, steering devices for vehicles provided to change the traveling direction of a vehicle each including a steering wheel provided on the driver's seat, a steering shaft coupled to the steering wheel, and a gear box disposed to have an axis crossing the steering shaft.

Especially, on both sides of the gear box, a tie rod which is moved in the axial direction of the gear box according to the movement of a rack bar sliding inside the gear box is provided.

An operating procedure of the typical steering device for vehicles configured as mentioned above is described below. When a user of a vehicle rotates the steering wheel, then the steering shaft coupled to a lower portion of the steering wheel is thereby rotated, then the rotary motion of the steering shaft is converted into a linear motion through the gear box which is coupled to the steering shaft such that the axis thereof crosses the steering shaft, and then the rack bar coupled to the steering shaft is moved in a direction parallel to the ground.

Here, when the rack bar is moved, the tie rod coupled to the rack bar is also moved in the same direction as the rack bar, and a ball joint including a ball joint housing, a ball stud which is inserted in the ball joint housing, and the like is also moved in the same direction as the rack bar according to the movement of the tie rod.

FIG. 1 illustrates a state in which tie rods 2 are respectively disposed on both left and right ends of a rack bar 1 and a ball joint 3 is disposed on both ends of the tie rods 2, and FIG. 2 schematically illustrates a ball joint.

As illustrated in FIG. 2, the ball joint 3 is inserted to be mounted in a ball joint housing 20 in a state in which a ball head 11 formed on a ball stud 10 is inserted in a ball seat 30, and here, the ball stud 10 rocks in all directions as the tie rod is moved.

Also, a fixing portion 21 is provided such that a dust cover 40 is closely fixed on an upper portion of the ball joint housing 20, a caulking portion 23 is provided to prevent the ball head 11 formed on the ball stud 10 from being separated from the inside of the ball joint housing 20.

Also, the dust cover 40 for preventing foreign substances from penetrating into the ball joint housing 20 is coupled to the upper end of the ball joint housing 20 so as to surround the outside of the ball stud 10 and the caulking portion 23.

A typical tie rod end configured as mentioned above has limitations in that: while the caulking portion 23 is inwardly bent through pressure forming, a predetermined portion of the fixing portion 21 which is located at a position continuously connected to the outer surfaces of the caulking portion 23 is pressure formed together with the caulking portion 23 to be inwardly bent, and the area of the surface brought into close contact with the dust cover 40 in the fixing portion 21 is decreased by an amount of bending of the fixing portion 21, and thus, when the dust cover 40 is brought into close contact with the fixing portion 21 to be fixed to the fixing portion 21, the close contact area between the dust cover 40 in the fixing portion 21 is decreased and thereby the dust cover 40 may not be firmly fixed on the fixing portion 21.

Also, since the caulking portion 23 has a small thickness to thereby have a small strength, when the caulking portion 23 is pressure formed to be inwardly bent, there is a problem in that the caulking portion 23 is damaged, and also a problem in that when used for a long time, the caulking portion 23 is damaged and the ball head 11 inserted in the ball joint housing 20 is separated to the outside.

### SUMMARY OF THE INVENTION

The present invention provides a ball joint housing maximizing manufacturing efficiency and improving durability by preventing in advance a decrease in contact area with a dust cover and preventing a portion deformed due to a process from being damaged when the process in which a ball head of a ball stud is pivotably supported in an inner space of the ball joint housing is performed.

According to an aspect of the present invention, a ball joint housing, which pivotably supports a ball head of a ball stud received in an inner space thereof and in which a dust cover is installed to prevent foreign substances from entering into the inner space, includes: a receiving limit providing portion for providing a limit in receiving the ball head in the inner space; a contact portion integrally formed with the receiving limit providing portion, wherein the dust cover is brought into contact with the contact portion; and a deformation portion integrally formed with the contact portion; wherein a process in which the deformation portion is deformed inwardly proceeds when the ball head is received in the inner space, wherein the ball head received in the inner space is prevented from being separated by the process, wherein the deformation portion is provided with a first thickness portion and a second thickness portion which are sequentially positioned in an upward direction from the contact portion, and wherein the first thickness portion is provided to have a thickness equal to or greater than that of the contact portion such that when the process is completed and the dust cover is brought into contact with the contact portion, an outer surface of the first thickness portion does not protrude outside an outer surface of the contact portion and thereby the dust cover is brought into contact with the contact portion without interfering with the first thickness portion after the process is completed.

The first thickness portion may be formed to have a same thickness as the contact portion before the process and inner and outer surfaces thereof may be bent in an inward direction by the process.

The contact portion and the first thickness portion may have a uniform thickness in an upward direction before the process.

The contact portion may not be deformed by the process.

The second thickness portion may be provided to have a thickness smaller than the first thickness portion before the process.

The second thickness portion may be provided with a thickness decreasing linearly or nonlinearly in the upward direction before the process.

The contact portion and the deformation portion may be provided with inner surfaces with a same diameter in the upward direction before the process.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a typical steering device for vehicles;

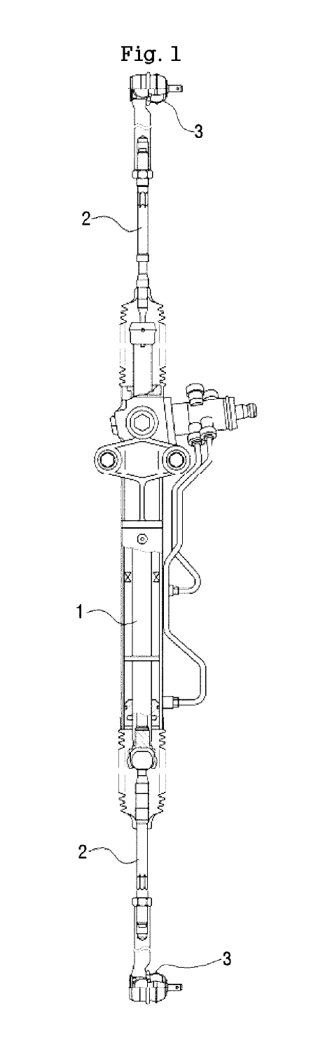

FIG. 2 is a schematic cross-sectional view illustrating a typical ball joint;

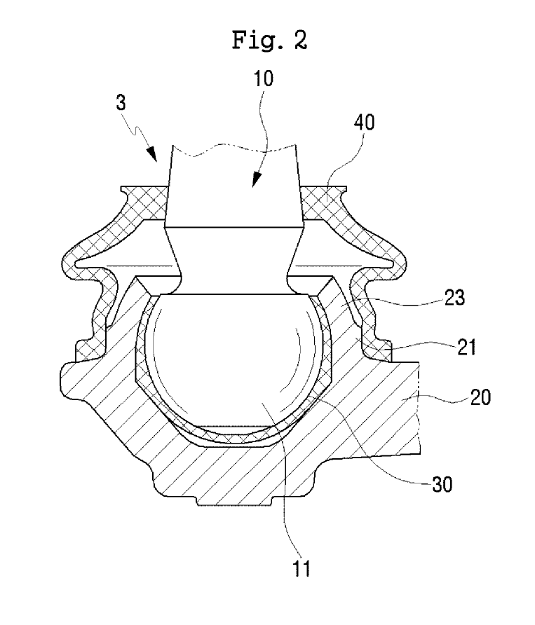

FIG. 3 is a schematic cross-sectional view illustrating a ball joint including a ball joint housing according to an embodiment of the present invention;

FIG. 4 is a schematic cross-sectional view illustrating a ball joint housing according to an embodiment of the present invention; and

FIG. 5 is a schematic view for describing a process for manufacturing a ball joint including a ball joint housing according to an embodiment of the present invention.

### DETAILED DESCRIPTION OF THE INVENTION

Hereinafter, specific embodiments of the present invention will be described in detail with reference to the drawings. The spirit and scope of the present disclosure, however, shall not be construed as being limited to embodiments provided herein. Rather, it will be apparent that other embodiments that fall within the spirit and scope of the present disclosure may easily be derived through adding, modifying, and deleting elements herein by those skilled in the art. However, such embodiments are also construed as being included in the spirit and scope of the present disclosure.

Like reference numerals denote like elements, included in the drawing of each embodiment and having the same function under the same inventive concept.

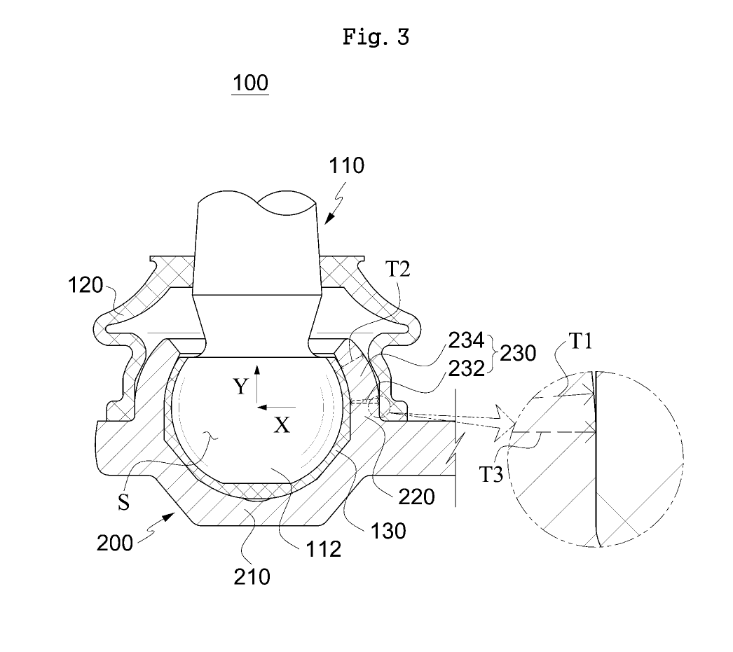

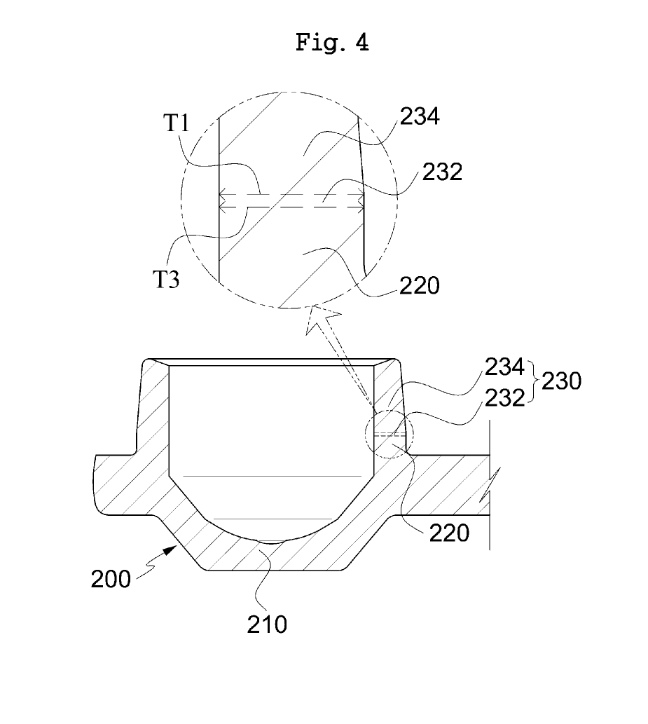

FIG. 3 is a schematic cross-sectional view illustrating a ball joint including a ball joint housing according to an embodiment of the present invention, and FIG. 4 is a schematic cross-sectional view illustrating a ball joint housing according to an embodiment of the present invention.

Firstly, terms regarding directions used below are defined such that an inward direction and an upward direction are X-arrow direction and Y-arrow direction respectively illustrated in FIG. 3.

Referring to FIG. 3, a ball joint 100 according to the present invention may include a ball joint housing 200, a ball stud 110 provided with a ball head 112, a dust cover 120, and a ball seat 130.

Specifically, the ball joint 100 is received in an inner space S of the ball joint housing 200 while the ball head 112 of the ball stud 110 is inserted in the ball seat 130, and then may be implemented through a bending process of the ball joint housing 200 such as caulking, and the ball head 112 may be pivoted in the inner space S while being supported by the ball joint housing 200.

Here, the ball head 112 may be received in the inner space S while being inserted in the ball seat 130, and the ball seat 130 may reduce friction force between the ball head 112 and the ball joint housing 200.

The ball seat 130 may be manufactured of a resin or the like and may be formed to have a portion of the inner surface thereof, the portion being recessed such that surface pressure applied to the ball head 112 is alleviated.

Also, the dust cover 120 may be installed on the ball joint housing 200 to prevent foreign substances from entering into the inner space S and to be brought into contact with a contact portion 220 in the ball joint housing 200. This will be described later.

Referring to FIG. 4, a ball joint housing 200 according to an embodiment of the present invention, as described above may be a kind of a pivot supporting structure of a ball head 112 which pivotably supports the ball head 112 of a ball stud 110 received in an inner space S, and which prevents foreign substances from entering into the inner space S by being provided with a dust cover 120.

The ball joint housing 200 may include a receiving limit providing portion 210, a contact portion 220, and a deformation portion 230, and hereinafter, the above constituent elements will be described in detail.

The ball joint housing 200 may have an overall semi-spherical shape which has an opened upper side and a closed lower side, and the receiving limit providing portion 210 may be a constituent element providing a receiving limit of the ball head 112 in the inner space S.

In other words, the receiving limit providing portion 210 may be a kind of a lower wall defining a space in which the ball head 112 may enter when the ball head 112 enters toward the inner space S.

The contact portion 220 may be a constituent element integrally extending with the receiving limit providing portion 210 and brought into contact with the inner surface of the dust cover 120 such that the dust cover 120 is fixed to the ball joint housing 200.

The deformation portion 230 may be a constituent element integrally formed with the contact portion 220 and preventing the ball head 112 received in the inner space S from being separated by being inwardly deformed by a bending process such as caulking when the ball head 112 is received in the inner space S in a state of being inserted in the ball seat 130.

Here, the deformation portion 230 may have a non-uniform thickness in the upward direction from the contact portion 220, and specifically, may have a first thickness portion 232 and a second thickness portion 234 which are sequentially located in the upward direction from the contact portion 220.

The thickness T1 of the first thickness portion 232 may be equal to or greater than the thickness T3 of the contact portion 220, and the thickness T2 of the second thickness portion 234 may be smaller than the thickness Ti of the first thickness portion 232.

For example, the first thickness portion 232 may have the same thickness (T1=T3) as the contact portion 220 before the process, and the second thickness portion 234 may have the thickness T2 decreased linearly or nonlinearly in the upward direction before the process.

Also, the contact portion 220 and the first thickness portion 232 may have a uniform thickness in the upward direction before the process, and the contact portion 220, the first thickness portion 232, and the second thickness portion 234 may have an inner surface having the same diameter in the upward direction before the process.

The process, in which the first thickness portion 232 of the deformation portion 230 is inwardly deformed while the ball head 112 is inserted in the ball seat 130, is completed, and when the dust cover 120 is brought into contact with the contact portion 220, the outer surface of the first thickness portion 232 may not protrude to the outside of the outer surface of the contact portion 220 so as not to interfere with the dust cover 120.

In other words, the outer and inner surfaces of the first thickness portion 232 may be bent in the inward direction by the process, and even when the outer surface is located outside the outer surface of the contact portion 220 before the process (or, even when the thickness of the first thickness portion 232 is greater than the thickness of the contact portion 220) the outer surface of the first thickness portion 232 finally does not protrude to the outside of the outer surface of the contact portion 220 by the process.

Of course, as illustrated in FIG. 4, when the first thickness portion 232 and the contact portion 220 have the same thickness and outer surface, the outer surface of the first thickness portion 232 may be naturally positioned in the inward direction of the contact portion 220 by the process.

As described above, since the outer surface of the first thickness portion 232 does not protrude outside the outer surface of the contact portion 220, and when the dust cover 120 is inserted in the deformation portion 230 and the contact portion 220, since the dust cover 120 may be contactingly fixed to the contact portion 220 without interfering with the deformation portion 230, the present invention has a remarkable effect of preventing in advance coupling force between the dust cover 120 and the contact portion 220 from being decreased because the dust cover 120 is interfered with the deformation portion 230 before being brought into contact with the contact portion 230.

Also, in the present invention, since the strength of the deformation portion 230 is reinforced by the thickness T1 of the first thickness portion 232 which is provided to be equal to or greater than the thickness T3 of the contact portion 220, damage to the deformation portion 230 may be prevented in advance even when performing the process of bending the first and second thickness portions 232 and 234 in the inward direction, that is, even when performing pressure-forming, and the separation of the ball head 112, which may be caused by the damage of the deformation portion 230 even when used for a long time, may be prevented in advance.

Furthermore, there is a remarkable effect in that support force with respect to the ball head 112 may be improved to maximize a pull-out load.

Also, the contact portion 220 may not be deformed by the process of bending the first and second thickness portions 232 and 234 in the inward direction, and this may be implemented due to the first thickness portion 232 having the thickness equal to or greater than that of the contact portion 220.

In other words, this is because when the process in which the deformation portion 230 is inwardly deformed while the ball head 112 is inserted in the ball seat 130 in the inner space S, the inward deformation is performed only up to the first thickness portion 232.

Also, it is obvious that the case in which the thickness Ti of the first thickness portion 232 is provided to be equal to or greater than the thickness T3 of the contact portion 220 is not limited to the embodiment described above, but may be variously modified.

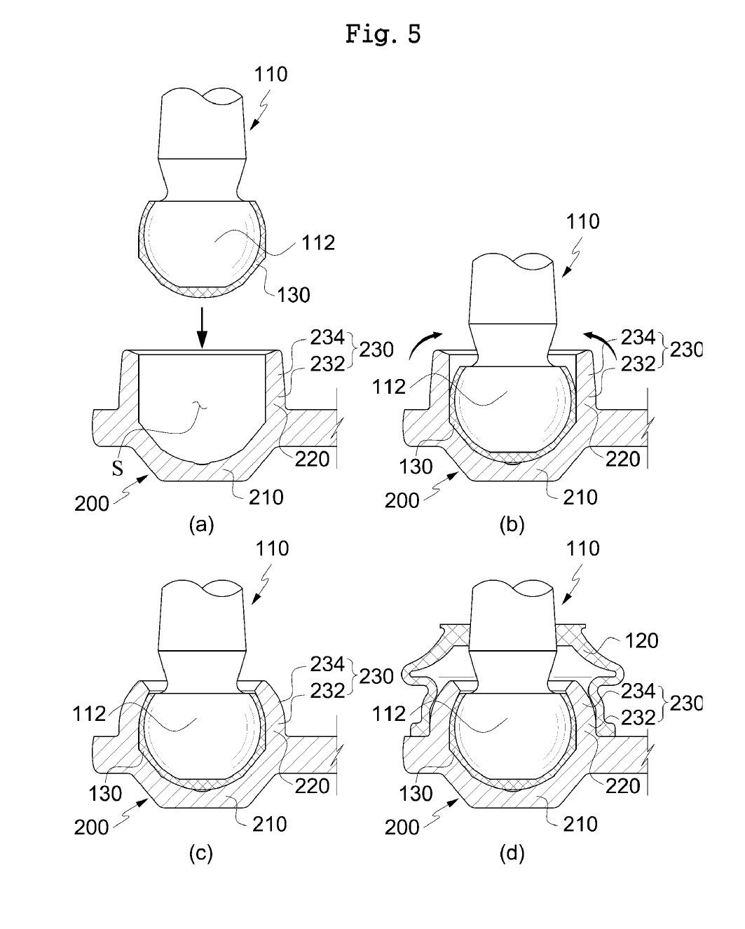

FIG. 5 is a schematic view for describing a process for manufacturing a ball joint including a ball joint housing according to an embodiment of the present invention.

Referring to FIG. 5A, the ball joint housing 200 is formed through a forging or casting process, or the like. In this case, a receiving limit providing portion 210, a contact portion 220, and a deformation portion 230 which are described above are formed in the ball joint housing 200.

Referring to FIG. 5B, a ball head 112 of a ball stud 110 is inserted in a ball seat 130, and then the ball head 112 inserted in the ball seat 130 is inserted in an inner space S of the ball joint housing 200.

When the insertion of the ball head 112 into the inner space S is completed, as illustrated in FIG. 5C, a bending process such as caulking in which the deformation portion 230, that is, first and second thickness portions 232 and 234 are inwardly bent is performed.

In this case, the contact portion 220 may not be deformed due to the first thickness portion 232, and the outer surface of the first thickness portion 232 may not protrude to the outside of the outer surface of the contact portion 220.

Also, damage to the deformation portion 230 may be prevented due to the first thickness portion 232 in the process.

Referring to FIG. 5D, after the process is completed, a dust cover 120 for preventing foreign substances from penetrating into the inner space S is brought into close contact with the contact portion 220 to be fixed while surrounding the deformation portion 230.

In this case, since the outer surface of the deformation portion 230 does not protrude outside the outer surface of the contact portion 220, the dust cover 120 may be stably brought into contact with and fixed to the contact portion 220 without interfering with the deformation portion 230.

According to the purpose of the present invention, a ball joint housing may prevent a decrease in coupling force between a dust cover and the ball joint housing by preventing, in advance, a decrease in contact area of the housing with the dust cover when performing a process in which a ball head of a ball stud is pivotably supported in an inner space of the housing.

Also, a portion deformed due to the process may be prevented from being damaged to maximize manufacturing efficiency.

Also, a pull-out load of the ball stud may be improved to maximize durability.

Although the configuration and characteristic of the present invention have been described in the above with respect to exemplary embodiments of the present invention, it is obvious to one ordinary skilled in the art that the present invention should not be limited to these exemplary embodiments but various changes and modifications can be made within the spirit and scope of the present invention as hereinafter claimed. Thus, such changes or modifications should be understood as falling within the claims of the present invention.

What is claimed is:

1. A ball joint housing, which pivotably supports a ball head of a ball stud received in an inner space thereof and in which a dust cover is installed to prevent foreign substances from entering into the inner space, the ball joint housing comprising:
a receiving limit providing portion for providing a limit in receiving the ball head in the inner space;
a contact portion integrally formed with the receiving limit providing portion, wherein the dust cover is brought into contact with the contact portion; and
a deformation portion integrally formed with the contact portion;
wherein a process in which the deformation portion is deformed inwardly proceeds when the ball head is received in the inner space,
wherein the ball head received in the inner space is prevented from being separated by the process,
wherein the deformation portion is provided with a first thickness portion and a second thickness portion which are sequentially positioned in an upward direction from the contact portion, and
wherein the first thickness portion is provided to have a thickness equal to or greater than that of the contact portion such that when the process is completed and the dust cover is brought into contact with the contact portion, an outer surface of the first thickness portion does not protrude outside an outer surface of the contact portion and thereby the dust cover is brought into contact with the contact portion without interfering with the first thickness portion after the process is completed.

2. The ball joint housing of claim 1, wherein the first thickness portion is formed to have a same thickness as the contact portion before the process and inner and outer surfaces thereof are bent in an inward direction by the process.

3. The ball joint housing of claim 1, wherein the contact portion and the first thickness portion have a uniform thickness in an upward direction before the process.

4. The ball joint housing of claim 1, wherein the contact portion is not deformed by the process.

5. The ball joint housing of claim 1, wherein the second thickness portion is provided to have a thickness smaller than the first thickness portion before the process.

6. The ball joint housing of claim 5, wherein the second thickness portion is provided with a thickness decreasing linearly or nonlinearly in the upward direction before the process.

7. The ball joint housing of claim 1, wherein the contact portion and the deformation portion are provided with inner surfaces with a same diameter in the upward direction before the process.

8. The ball joint housing of claim 1, wherein the contact portion and the first thickness portion are provided with inner surfaces with a same diameter in the upward direction before the process.
